(19) United States
(12) Patent Application Publication
(10) Pub. No.: US 2008/0203948 A1
(43) Pub. Date: Aug. 28, 2008

(54) Lighting device

(75) Inventors: Ching-Huei Wu, San Chung City (TW); Yuan-Cheng Chin, San Chung City (TW); Tai-Ho Huang, San Chung City (TW)

Correspondence Address: TROXELL LAW OFFICE PLLC, SUITE 1404, 5205 LEESBURG PIKE, FALLS CHURCH, VA, 22041, US

(73) Assignee: Unity Opto Technology Co., Ltd.

(21) Appl. No.: 11/711,157

(22) Filed: Feb. 27, 2007

(51) Int. Cl. H05B 37/02

(52) U.S. Cl. 315/320

(57) ABSTRACT

A lighting device includes a control circuit board and a plurality of light-emitting diodes. The light-emitting diodes are electrically connected to the control circuit board and each light light-emitting diode includes at least a red-light chip, a blue-light chip, and a green-light chip. The control circuit board forms a control circuit that includes a band switch. Operation of the band switch allows switching of the light-emitting diodes among emission of light of different preset colors.

### FIELD OF THE INVENTION

The present invention relates to a lighting device that is easy to manufacture and is switchable among emission of light of different colors, and is particularly applicable to light-emitting diodes or the likes for illumination purposes.

### BACKGROUND OF THE INVENTION

Light-emitting diodes of multiple colors and lower power consumption are already available and are widely applied to lighting decoration or illumination purposes. Such light-emitting diodes, no matter what applications they are taken, are all economic in power consumption. Early light-emitting diodes were of a single-color and single-dice structure and later development provided light-emitting diodes with light emission of different colors, which makes it possible to combine a drive circuit and a plurality of light-emitting diodes of different colors to form a multi-color displaying device. However, the multi-color displaying device is comprised of a plurality of light-emitting units and this makes the displaying device bulky, in turn restrict the applications thereof.

With the rapid progress of the semiconductor technology, a multi-color light-emitting diode has been developed, of which an example is shown in FIGS. 3 and 4, wherein the multi-color light-emitting diode is generally represented by reference character A and comprises a circuit board A1, which forms conductive tracks on both top and bottom surfaces thereof; a drive chip A2, which is mounted to the bottom surface of the circuit board A1 and is electrically connected by the conductive tracks of the circuit board A1; three single-color chips A3, which are mounted to the top surface of the circuit board A1 and is electrically connected to the drive chip A2 of the bottom surface through the conductive tracks of the top surface; two external terminals A6, A7, which are electrically connected to the conductive tracks of the bottom surface of the control circuit A1; black resin A4, which covers and seals the drive chip A2 on the bottom surface of the control circuit A1; and transparent resin A5, which packages the circuit board A1, the single-color chips A3, and portions of the external terminals A6, A7.

When power is supplied through the external terminals A6, A7 to the light-emitting diode A, the drive chip A2 drives the single-color chips A3 to give off light of different colors whereby the light-emitting diode A, as a whole, emit lights of multiple colors. This structure, although effectively reducing the amount of space occupied by a multi-color displaying device employing the light-emitting diode A, requires the drive chip and the single-color chips to be respectively mounted on the top and bottom surfaces of the circuit board and electrically connected to corresponding conductive tracks. This is a complicate double-side processing, and particularly, diode mounting is a high temperature process, both making the pass rate of the conventional light-emitting diodes very low. Consequently, the price of the conventional light-emitting diode cannot be lowered down.

Thus, the present invention is aimed to provide a lighting device that is easy to manufacture and is switchable among emission of light of different colors, in order to overcome the drawbacks of the prior art.

### SUMMARY OF THE INVENTION

An objective of the present invention is to provide a lighting device that is easy to manufacture and is switchable among emission of light of different colors.

To realize the above objective, in accordance with the present invention, a lighting device is provided, comprising a control circuit board add a plurality of light-emitting diodes. The light-emitting diodes are electrically connected to the control circuit board and each light light-emitting diode comprises at least a red-light chip, a blue-light chip, and a green-light chip. The control circuit board forms a control circuit that comprises a band switch. Operation of the band switch allows switching of the light-emitting diodes among emission of light of different preset colors.

### BRIEF DESCRIPTION OF THE DRAWINGS

The present invention will be apparent to those skilled in the art by reading the following description of a preferred embodiment thereof with reference to the drawings, in which:

FIG. 1 is a perspective view of a lighting device constructed in accordance with the present invention;

FIG. 2 is a block circuit diagram of an illustrative example of the lighting device in accordance with the present invention;

FIG. 3 is a perspective view of a conventional light-emitting diode; and

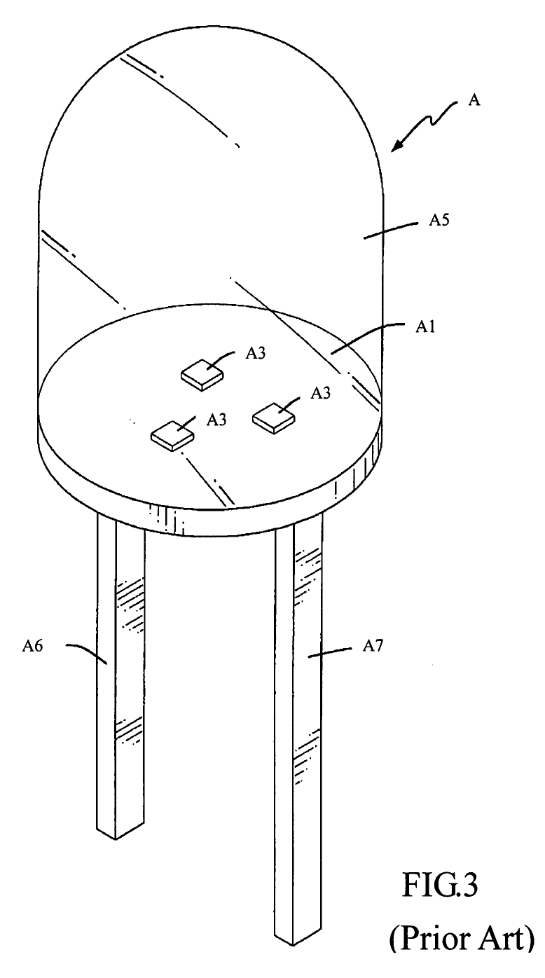

FIG. 4 is a bottom view of the conventional light-emitting diode shown in FIG. 3.

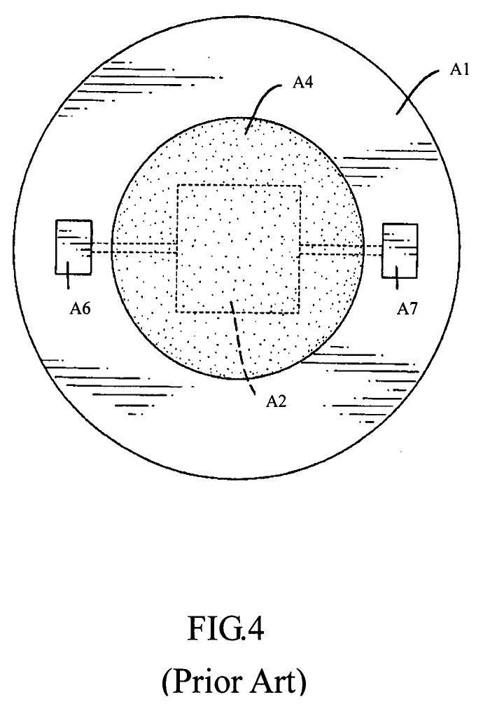

### DETAILED DESCRIPTION OF THE PREFERRED EMBODIMENT OF THE PRESENT INVENTION

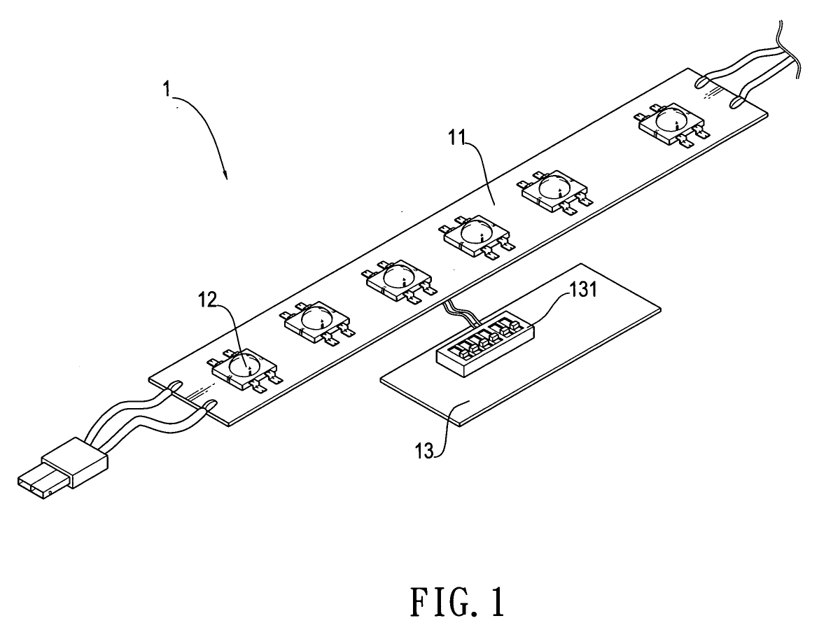

With reference to the drawings and in particular to FIG. 1, which shows a lighting device constructed in accordance with the present invention, generally designated with reference numeral 1, the lighting device 1 comprises a control circuit board 13 and a plurality of light-emitting diodes (LEDs) 12, the LEDs 12 being electrically connected to each other to form a circuit loop. In the embodiment illustrated, the LEDs 12 are mounted a substrate 11 having two power terminal contacts. The LEDs 12 mounted on the substrate 11 are further electrically connected to a the control circuit board 13, which comprises a control circuit that comprises a band switch 131 and that is preloaded with control data of multiple color lights in accordance with the characteristics of the LED chips.

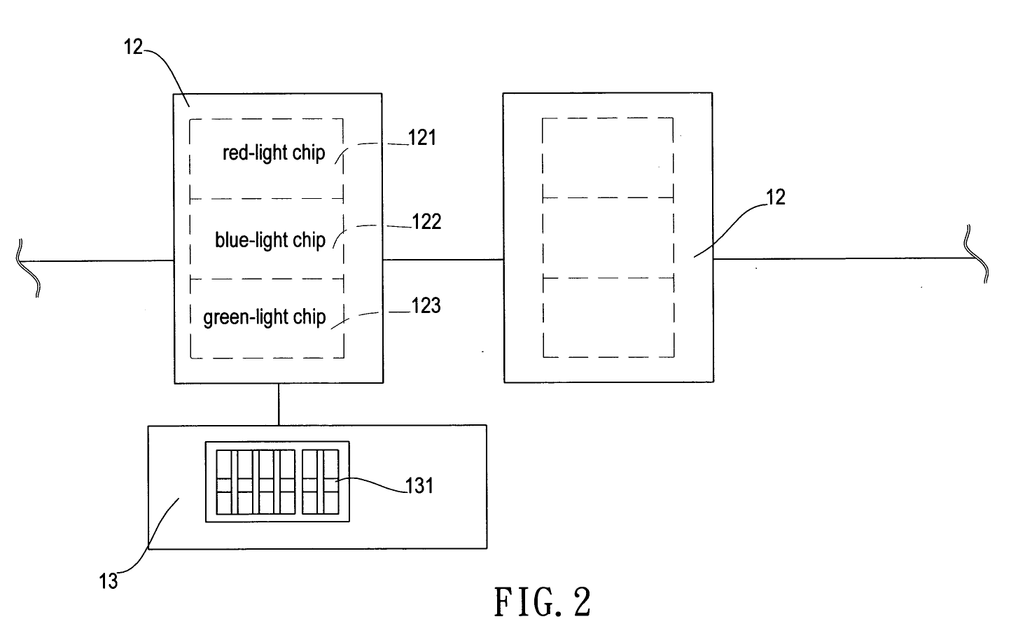

Each LED 12 includes at least a red-light chip 121, a blue-light chip 122, and a green-light chip 123, as shown in FIG. 2. The LEDs 12 are connected to form a circuit that is electrically connected to the control circuit board 13. Since the control circuit comprised of the control circuit board 13 is preloaded with the control data of multiple color lights in accordance with the characteristics of the chips and since the control circuit comprises a band switch 131, which can be for example a multi-stage DIP switch, the control circuit can control the LEDs 12 to switch among and emit the color lights that are preset in the control circuit through the switching operation performed by the band switch 131.

When the lighting device 1 is supplied with electrical power, all the LEDs 12 on the substrate 11 emit the particular color light that is currently set by the band switch 131. After a long period of time of use of the lighting device 1 or when a particular requirement is given, the band switch 131 of the control circuit board 13 is operated to switch among the control data of the multiple color lights preset in the control circuit to change the color of light emitted by the LEDs 12. Thus, the lighting device 1 features adjustment or modification of the color of the light emitted thereby whereby a variety of applications and uses of the lighting device 1 can be realized.

To this point, it is apparent that the present invention provides a lighting device that is easy to manufacture and is switchable among emission of light of different colors. Thus, the present invention is of value of utilization.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A lighting device comprising a control circuit board and a plurality of light-emitting diodes, wherein the light-emitting diodes are electrically connected to the control circuit board, and each light light-emitting diode comprising at least a red-light chip, a blue-light chip, and a green-light chip; and wherein the control circuit board comprises a control circuit that comprises a band switch, whereby switching operation of the band switch allows switching of the light-emitting diodes among emission of light of different preset colors.

2. The lighting device as claimed in claim 1, wherein the control circuit is pre-loaded with control data of multiple colors of light in accordance with characteristics of the chips.
